(19) United States
(12) Patent Application Publication
(10) Pub. No.: US 2009/0017175 A1
(43) Pub. Date: Jan. 15, 2009

(54) Food packaging process

(75) Inventors: Daniel C. Jackson, Wexford, PA (US); Robert L. Delaney, Wexford, PA (US); Joseph P. DeStephano, Pittsburgh, PA (US); Heather M. Mayernik, Pittsburgh, PA (US); John J. Oleksa, Wexford, PA (US)

Correspondence Address: BUCHANAN, INGERSOLL & ROONEY PC, POST OFFICE BOX 1404, ALEXANDRIA, VA, 22313-1404, US

(73) Assignee: H.J. HEINZ COMPANY, Pittsburgh, PA (US)

(21) Appl. No.: 12/232,382

(22) Filed: Sep. 16, 2008

Related U.S. Application Data
(62) Division of application No. 11/258,147, filed on Oct. 26, 2005.

(51) Int. Cl. A23L 1/01; A23L 1/00

(52) U.S. Cl. 426/243; 426/389

(57) ABSTRACT

A reheatable container for food items includes an annular body portion having a large, centrally positioned, opening surrounded by a generally planar flange. A generally circular disk covers the opening and is supported by the planar flange. The upper edge structure of the body portion includes a generally planar sealing surface to which a transparent quadrilateral cover film is sealed. The body portion is preferably fabricated from CPET. The food item may be heated in the container at the time of preparation, shipped in the container, stored in the container, and reheated in the container. Removal of the circular disk simultaneously removes the food item from the body portion.

This is a divisional of application Ser. No. 11/258,147, filed on Oct. 26, 2005.

### FIELD OF THE DISCLOSURE

This disclosure generally relates to a food container suitable for distribution of a food item to consumers. More particularly, the disclosure concerns a food container suitable for initial baking of a food item, subsequent distribution of that food item, and reheating or final preparation of the food item by the ultimate purchaser.

### BACKGROUND

Many products are prepared commercially for distribution to consumers, which products require re-heating, tempering, and/or thawing before consumption. Typical products are pies, cakes, and other dessert items. With more and more frequency, such products are being created with toppings and creative embellishments to enhance their presentation to the ultimate consumer. Where the product is a baked or pre-cooked item, the normal manufacturing process includes baking or cooking in commercial cookware, removal of the prepared item from the commercial cookware, and packaging the prepared item for distribution and ultimate sale. Sometimes, an aluminum tray may be used for manufacturing. During distribution a plastic dome may or may not be used or a paperboard sleeve with shrink-wrap may be used.

For some such products, reheating is required immediately before serving to finish off the cooking or baking process and/or to provide the aura of a freshly baked product. Normally, such reheating involves removal of the food item from its distribution package, application of toppings and/or embellishments, and reheating in local cookware. Occasionally, pre-decorated frozen products are served in an aluminum pan.

Those processing steps tend to be both time consuming and labor intensive. For example, removal of commercial quantities of baked items from commercial cookware requires manipulation of the baked items either by hand or by additional mechanized equipment. Regardless of whether such manipulation is manual or mechanized, it gives rise to product loss through breakage and/or damage as well as a greater potential for product contamination. Moreover, such manipulation increases production costs through yield loss, increased labor costs, and/or through cost, depreciation, and maintenance of the necessary equipment including, without limitation, cleaning and sanitizing equipment.

Furthermore, when toppings and/or embellishments are applied to the food item before presentation for consumption, they are typically done manually, item by item. That results not only in increased cost but also in lack of uniformity in the finished item.

Accordingly, it will be apparent to those skilled in the art that the need continues to exist for packaging and processes which overcome one or more of such deficiencies.

### SUMMARY

To obviate the need for removing the food item from commercial cookware, a food container according to this disclosure functions both as the baking cookware and the transportation container. Moreover, to further minimize handling of the food item, the container may also be used to reheat the food item if necessary. To effectuate those features, the body of the food container of this disclosure is fabricated from a food-grade material that maintains its structural integrity during two or more heating cycles, as well as during freezing and/or shipping. A suitable material is a thermoplastic polyester, such as crystalline polyethylene terephthalate (CPET). Depending upon the application, the body may also be fabricated from a microwave susceptor material or include a microwave susceptor coating thereon.

The configuration of the food container enhances its ability to reduce handling and transfer of food product. More particularly, the food container comprises three components: a body portion, a removable bottom, and a transparent seal sheet.

The body portion is preferably fabricated from, for example, CPET. Preferably, the body portion is annular with a sidewall that diverges upwardly away from a bottom flange. This arrangement eases product removal from the container. The bottom flange of the body portion defines a generally circular opening that is covered by the removable bottom element.

The removable bottom element may be fashioned from CPET, corrugated board, or paperboard depending upon the required resistance to lateral deflection, required heat tolerance, and cost. As long as the food container will not be subjected to temperatures exceeding the kindling temperature of paper (about 450° F.) corrugated board and paperboard are preferred. Preferably, the bottom element includes a non-stick coating. If desired, a microwave susceptor coating may also be provided on the bottom element.

To protect product in the container from environmental degradation, and damage from handling, the open mouth of the body portion is preferably covered by a transparent sheet of plastic material that can be sealed to the material of the body portion. To this end, the open mouth of the body portion is circumscribed by an annular, planar sealing flange to which the transparent sheet may be sealed. Sealing may be effected in any suitable manner, e.g., by thermal bonding, adhesive, and the like. To simplify the covering process, the transparent sheet is cut with parallel sides having a quadrilateral shape, rather than in a generally circular shape to conform to the shape of the sealing flange. Nevertheless, if desired, the transparent sheet may be conform to the top of the body portion and may even include a pull tab to facilitate its removal.

With the removable bottom in place, the body portion may function as cookware and can receive a food item to be baked or otherwise pre-cooked. The food item, in the body portion assembly, may be cooked for a suitable length of time. After the baking or cooking, the container and the food item are handled together, so that it is unnecessary to separate the food item from its associated cookware. After baking or cooking, the container and the food item are cooled. Suitable toppings and/or fanciful embellishments may then be applied to food item so that product uniformity exists.

The cooled, decorated food item is then covered with the transparent sheet, which is sealed to the flange of the body portion. Depending upon the food item, the packaged item may be frozen. Thereafter the food item, in its original package, is distributed to the ultimate purchaser.

To prepare the food item for consumption, the ultimate purchaser removes the transparent cover sheet and tempers, thaws, and/or reheats the food item, still in its original container. When the food item is finally ready for presentation to the dining person, the removable bottom is pushed upwardly while the body portion is restrained or pushed downwardly, thereby releasing the food item while continuing to support it on the removable bottom element. The food item may then be placed on a flat serving piece and presented to the dining person without further need to embellish it.

### BRIEF DESCRIPTION OF THE DRAWINGS

Many objects and advantages of the invention will be apparent to those skilled in the art when this written description is read in conjunction with the attached drawings wherein like reference numerals are applied to like elements and wherein:

FIG. 1 is an exploded view of a food container;

FIG. 2 is a top view of the food container;

FIG. 3 is a partial cross-sectional view taken along the line 3-3 of FIG. 2;

FIG. 4 is a side view of the container;

FIG. 5 is a partial cross-sectional view of a stack of container bodies; and

FIG. 6 is a schematic diagram of processes using the food container.

### DETAILED DESCRIPTION OF THE PREFERRED EMBODIMENTS

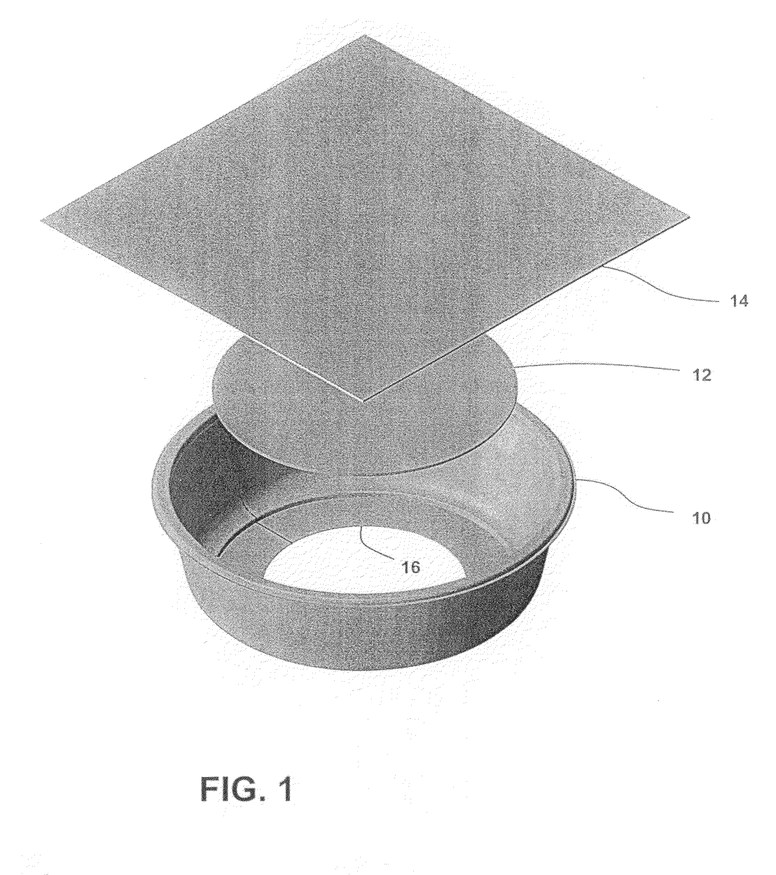

A food container (see FIG. 1) according to this invention includes a body portion 10, a bottom 12, and a cover 14. The body portion 10, the first component, is preferably fabricated from a food-grade material that maintains its structural integrity during food product preparation and two or more heating cycles. Suitable materials include thermosetting plastics and high-temperature thermoplastics. High-temperature thermoplastics are those which maintain their structural integrity and shape at conventional food heating temperatures, e.g., temperatures preferably up to about 500° F., and most preferably up to about 400° F. A preferred material is a thermoplastic polyester; and a particularly preferred material is crystalline polyethylene terephthalate (CPET).

The bottom 12, the second component, may be fashioned from any suitable material that is sufficiently rigid to support the product to be placed in the container and able to withstand conventional food heating temperatures. More particularly, the bottom material may be the same material as the body portion 10. However, the preferred material for the bottom 12 is corrugated board or paperboard. It should be noted that corrugated board or paperboard normally has a kindling temperature of about 450° F., and can withstand even higher temperatures when in surface contact with a food product being baked or reheated.

The third component, the cover 14, may be formed from a sheet material that can be sealed to the body portion either by thermal welding, thermal adhesion, or an adhesive. Preferably, the cover 14 is fashioned from a transparent material so that the container contents can be easily seen by prospective purchasers. Nevertheless, for some commercial applications it may be sufficient that the cover be opaque, or translucent. For example, where the purchasers know what the packaged item looks like transparency may not be necessary. Regardless of the transparency or opacity of the cover 14, it may be printed or otherwise provided with graphics.

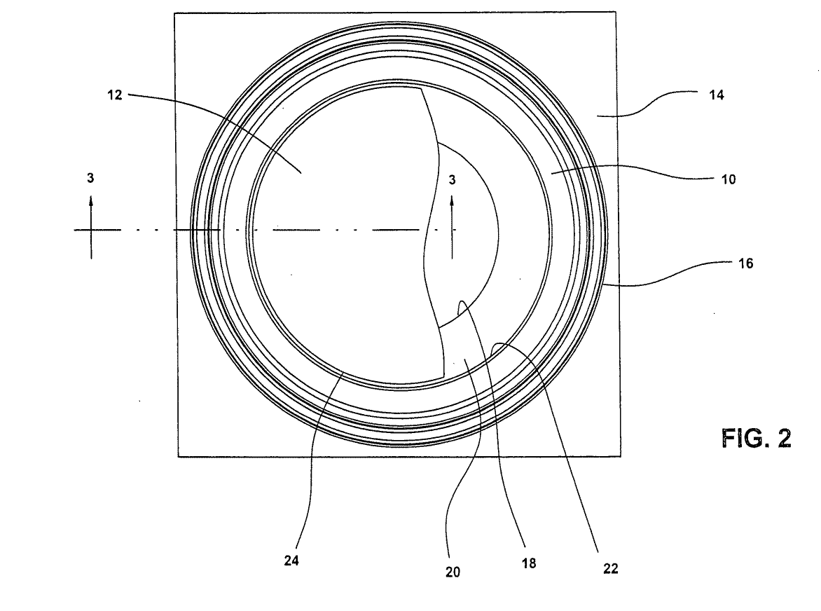

It is preferred that the material of the cover 14 have a width at least equal to the width of the body portion 10. Where, as shown in FIG. 2, the external contour 16 of the body portion 10 is generally circular, the cover 14 should have a width at least as large as the maximum diameter of that external contour 16 of the body portion 10. The cover 14 preferably has a length at least equal to the length, taken in a direction substantially perpendicular to the width, of the body portion 10. Again, where the body portion 10 is circular, the cover 14 should have a length at least as large as the maximum diameter of that external contour 16 of the body portion 10.

Preferably, the shape of the cover 14, when viewed from above, is a quadrilateral, such as a rectangle or a square. That cover configuration is preferred since it simplifies cutting of the cover 14 from a continuous sheet of material from which the cover 14 is cut. For example, a simple straight line cutting mechanism can be used to cut the cover 14 during covering of the container which is simpler and less expensive that a die cutting arrangement when the cover 14 is conformed to the external contour of the body portion 10. If desired, the cover 14 may extend beyond the external contour 16 of the body portion. By fabricating the cover 14 from a think flexible sheet material, the corners of the cover 14, as well as any portion protruding outwardly beyond the external contour 16, do not interfere with—and do not affect the dimensional sizing of—external packaging for the filled container, for example, a protective box of paperboard or other suitable material. Nevertheless, in some applications, it may also be desirable to conform the external contour of the cover 14 to the external contour 16 of the body portion.

An important characteristic of the body portion 10 is a central opening 18. While the opening 18 is depicted as being generally circular, if desired, the opening 18 may have other shapes such as generally round, generally elliptical, generally square, generally rectangular, generally polygonal, and the like. Preferably, the body portion 10 includes a substantially planar flange 20 surrounding the opening 18, and positioned at the bottom portion of the body portion 10. The distance from the opening 18 to the external contour 16 of the body portion is selected so that the fingers of a human hand can reach radially inwardly of the opening 18 while the palm of the hand rests at the external contour 16. A convenient radial distance between the opening 18 and the external contour 16 is about 2 inches. Expressed differently for a generally circular container, the ratio of the diameter of the external contour 16 to the diameter of the opening 18 is in the range of about 1.66 to about 3.0, preferably in the range of about 2.0 to about 2.25, and most preferably about 2.1.

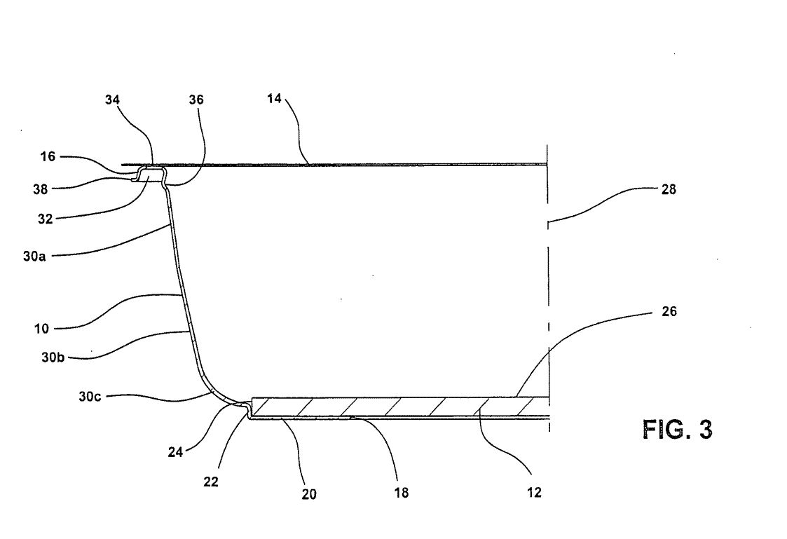

Disposed around the flange 20 is a generally vertical wall 22 (see FIG. 3) having a shape that substantially conforms to the external contour 24 of the bottom 12, when viewed from above. The wall 22 is dimensioned in the plane of the flange 20 so that a working clearance exists between it and the external contour 24 of the bottom 12. The clearance is preferably a small fraction of the radial dimension of the flange 20. With that arrangement, the bottom 12 can be placed in the body portion 10 to cover the opening 18, while a peripheral portion of the bottom overlies the flange 20 and is supported thereby. Meanwhile, the bottom 12 is constrained from movement parallel to the plane of the flange 20 by the wall 22 so that the opening 18 is always covered by the bottom 12 when supported by the flange 20. Moreover, a central portion of the bottom—inside the opening 18—is exposed from below the body portion 10 and is accessible there. This design arrangement allows the food product to be removed from the pan. Accordingly, when the container body portion 10 is held such that the palms of the hand are located at the external contour 16, the fingers of the hand can press on the central portion of the bottom 12. With that arrangement, when the fingers are articulated, the bottom 12 can be lifted relative to the body portion 10.

In addition, the wall 22 preferably has a height which does not project above the top surface 26 of the bottom 12. With this arrangement the presence of the bottom 12 is at least partially concealed when a product is removed from the container, as will be described in more detail below. Furthermore, the wall 22 is preferably inset from the peripheral wall 30 toward a central axis 28 of the body portion 10. That inset is effective to disguise the presence of the bottom 12 when the food item is viewed from the side. In addition, the wall 22 and the flange 20 may cooperate to define a foot at the bottom of the container body on which the container rests. That foot may also be received in a conforming cut-out in a package to restrain the container from sliding relative to such a package.

Preferably the container is used for food items such as entrees or desserts which require some heating during initial preparation and which may be frozen for storage and/or distribution. For example, such entrees or desserts may be pies, cakes, cupcakes, cheese cakes, tarts, savory tarts, quiches, and the like. The entrees or desserts may be individual portions or may be sufficiently large to provide multiple portions. For such food items, a preferred configuration for the container is round. Accordingly, the body portion 10 is substantially annular.

The peripheral wall 30 us generally frusto-conical, extends outwardly away from the axis 28 and outwardly away from the bottom 12. In addition, the peripheral wall 30 extends upwardly away from the bottom 12. The peripheral wall 30 may include an upper frusto-conical section 30a which forms a shallow angle relative to the axis 28, a lower frusto-conical section 30b which forms a larger angle relative to the axis 28, and a generously rounded corner 30c which may terminate at the wall 22. The shallow angle of the upper section 30a is preferably less than 10° but greater than 0°, and most preferably about 7°, and has a length measured parallel to the axis less than half the height of the body portion 10. The shallow angle of the lower section 30b is preferably less than about 15°, greater than about 10°, and most preferably about 12°. The lower section 30b also has a length measured parallel to the axis 28 less than half the height of the body portion 10 and less than the height of the upper section 30a. Preferably, the lower section 30b is tangent to the rounded corner 30c at least on the inside surface of the peripheral wall 30.

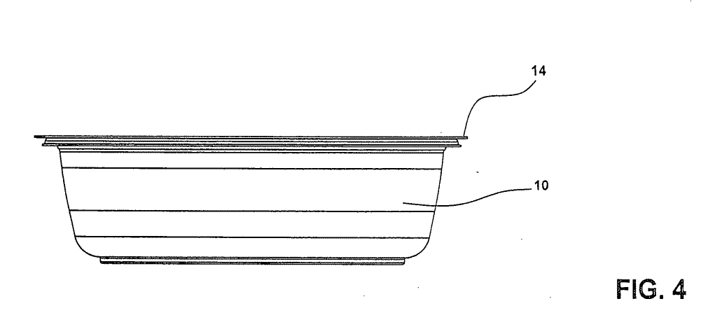

With a peripheral wall 30 having the characteristics described above, the container as well as a packaged food item can have a nearly vertical side edge (see FIG. 4). That edge shape gives the food product a nearly vertical edge. Furthermore, the small angles between the generally frusto-conical peripheral wall 30 and the axis 28 (see FIG. 3) enhance removal of the food item without edge damage at least in part because during removal of the food item resistance from the body portion 10 is at a small angle relative to the axis 28.

At the top of the upper frusto-conical section 30a, an edge structure 32 is provided. The edge structure extends radially outwardly from the upper section 30a. Further, the edge section 32 includes a substantially planar seal surface 34 which extends around the entire perimeter of the body portion 10. Where, the body portion 10 is generally annular, the seal surface 34 is also annular. Positioned between the seal surface 34 and the upper end of the upper frusto-conical portion 30a is an outwardly extending, limit protrusion 36, often called a stack shoulder. The protrusion 36 may extend entirely around the perimeter of the upper portion 30a, or it may comprise a plurality parts spaced around the perimeter of the upper portion 30a. When referred to herein, the protrusion 36 is intended to refer either to a continuous ridge or a plurality of ridges spaced from one another around the perimeter. It will be seen from FIG. 3 that the limit protrusion 36 has its maximum outward excursion from the central axis 28 at a position below the peripheral edge 38 of the edge structure 32.

Those structural characteristics of the edge structure 32 provide several functions. Because the edge structure 32 extends radially outwardly from the top of the upper section 30a, the edge structure 32 stiffens the upper portion of the frusto-conical section 30a against deflection by forces with components generally perpendicular to the axis 28. The seal surface 34 is generally open from below and provides a flat area where a seal can be effected between the body portion 10 and the cover 14. Being open from below, that seal surface 34 can be backed up by an anvil or similar structure if needed to effect the seal with the cover 14.

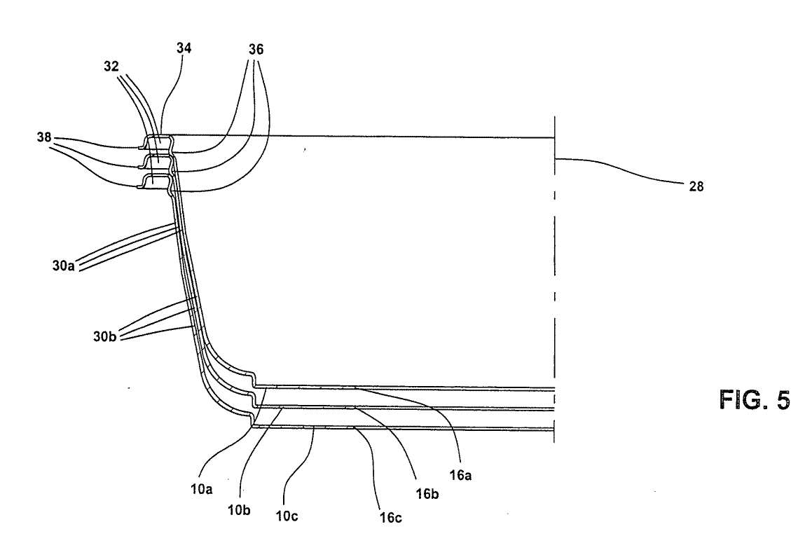

In commercial operations, it is important that the container components can be efficiently packaged. For many applications, it is also important that the body portions can be nested for use with automated equipment. The limit protrusion 36 materially assists providing those characteristics. As best seen in FIG. 5, body portions 10a, 10b, and 10c are in nested relationship with one another. The limit protrusion 36 of body portion 10a projects outwardly far enough to be engaged by the upper part of the edge structure 32 of the body portion 10b. Because all the body portions 10a, 10b, 10c are identical, the limit protrusion 36 establishes the vertical spacing between nested body portions. That spacing can be seen as the vertical distance in FIG. 5 between the peripheral edges 38 of the adjacent body portions.

To have nesting of body portions 10 and to assure that the nested body portions separate easily from one another, substantial surface contact between adjacent body portions should be minimized. Thus, the lower frusto-conical portion 30b has a larger angle relative to the axis 28 than does the upper frusto-conical portion 30a of each body portion 10. With that arrangement, when the body portions are nested with one another, the lower portions 30b have a small space therebetween. Furthermore, since each body portion 10a, 10b, 10c has a corresponding opening 16a, 16b, 16c in the bottom thereof, air can readily access the space between adjacent, nested, body portions. Accordingly, pressure differentials do not build up across the body portions when one is removed from a nested stack of body portions. That characteristic enhances the ease with which the body portions can be handled by automated equipment.

A container having the features described above can be used for effective packaging of various food items. The container is particularly useful for food items subjected to a heating process during preparation. Exemplary food items for which the container is well adapted include, without limitation, individually packaged entrees and desserts like pies, cakes, cupcakes, cheese cakes, and tarts.

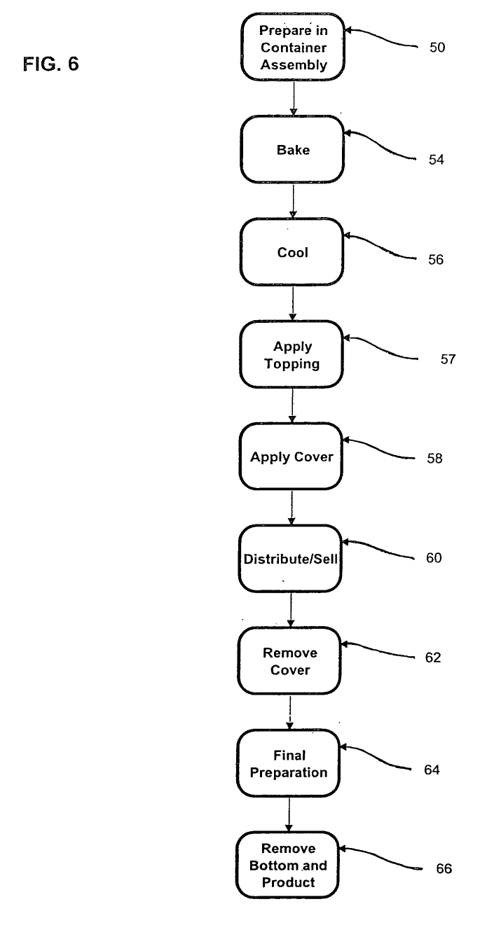

The first step in a process of using the container described herein (see FIG. 6) includes the preparing the entrée or dessert 50. This preparation step typically involves placing the container body 10 on an assembly line.

Then a bottom 12 (see FIG. 3) is placed in a body portion 10 such that (i) the edge 24 of the bottom 12 is laterally fixed by the endwall 22, (ii) the flange 20 supports the peripheral portion of the bottom 12, and (iii) the central portion of the bottom 12 covers the opening 18 in the body portion 10. When thus assembled, this container body assembly has an open top and is suited to receive the food item or dessert.

Next, the entrée or dessert is prepared in the container body assembly 50 (see FIG. 6). That preparation may simply include the step of depositing a predetermined quantity of batter in the container body assembly, where the quantity is sufficient to make a portion sized to suit one or more persons. Note that the container body assembly can be sized to accommodate a entree or dessert sufficient to provide six or more servings. For food items having a crust, the bottom crust is then pressed into the container body assembly. Then, a filling batter may be dispensed into crust for a filling. In the case of a covered pie, the preparation step 50 may further include applying a covering crust to the filled bottom crust.

The container assembly with its contents is then subjected to a heating process 54. That heating process may be a baking step during which the entree or dessert is subjected to elevated temperature for a predetermined period of time sufficient to cook or pre-cook the entree or dessert. Depending on the particular entrée or dessert being prepared, one or more heating steps may be used. Ordinarily, the heating step will be one that does not subject the container assembly to temperatures exceeding the temperature at which the container body begins to loose dimensional stability—i.e., begins to deform.

After the heating step 54, the container assembly with its heated contents is cooled 56. That cooling step 56 may be accomplished by simple passive cooling where the temperature of the container assembly and its contents are permitted to drop to ambient temperature. Alternatively, the cooling step may be an active cooling step where the container assembly and its contents are convectively cooled and/or subjected to a low-temperature or refrigerated environment.

If the entrée or dessert is to have a surface treatment such as a topping, icing, surface decoration, or surface embellishment, the topping is preferably applied 57 to the surface of the food item at this point in the process. Preferably, any such surface treatment does not extend above the seal surface 34 (see FIG. 3) of the container body 10 so that the surface treatment will not be touched by the cover.

With the dessert or entrée now prepared, it is covered 58 (see FIG. 6) by applying the cover 14 (see FIG. 3) and sealing it the seal surface 34 of container body so as to prevent foreign matter and foreign objects from contacting the entrée or dessert in the container. Preferably, the cover 14 is transparent so that the entrée or dessert can be seen and visually inspected from outside the container. Preferably, the cover material is cut transversely so that the cut is substantially perpendicular to the side edges of the cover. In this way, specialized equipment for trimming the cover to conform to the contours of the container body 10 is unnecessary. Nevertheless, it is also contemplated that the cover material be cut so as to conform to the shape of the container body 10.

Depending upon the food item and its storage requirements, the covered container, with the entrée or dessert therein, may be frozen or refrigerated in preparation for distribution and or sale. If desired, the container with the food item may also be packaged in an external carton or the like. In some instances, the container body 10 and/or the bottom element 12 may be tacked to such an external carton to resist relative movement during shipping and handling. That tacking may be effected with a suitable adhesive or a sticky substance. Where the food item includes an ingredient like caramel, small quantities of the ingredient (e.g., drops, dots, etc.) can be used for the sticky substance.

The container and the food item are then distributed and/or sold 60 (see FIG. 6) to the end user.

To prepare the food item for consumption, the end user removes the cover 62 from the package to ready it for a final preparation step 64 that may include a thawing, tempering, or reheating process. That preparation step 64 may involve partially opening the cover to expose the contents, depending upon the particular entrée or dessert and the preferred reheating technique. The entrée or dessert may then be thawed, tempered, or reheated in final preparation for presentation to the consumer. That reheating step 64 may simply be a warming step or it may be a baking step having a significant duration. Depending upon the type of food item, the food item along with the bottom may be removed from the container body followed by a thawing or tempering step. For other food items, the food may be thawed or tempered in the container, followed by removal of the bottom (and the food item) from the body. Still other food items, may be reheated in an oven or microwave oven after which the bottom and food item are separated from the body portion of the container.

Those skilled in the art will appreciate that the container body in which the entrée or dessert was initially heated 54, is the same container body in which the final reheating step 64 occurs. Thus, during manufacture, there is no need to remove the heated entree or dessert from commercial bakeware. Accordingly, cleaning of such commercial bakeware is eliminated. Moreover, equipment to effect that removal and cleaning is not required when the container described herein is used.

When the entrée or dessert is ready to be served, the false bottom and contents are removed 66 from the container body 10 (see FIG. 3). More specifically, the body portion 10 can be supported against the palms of opposed hands, while fingers from those opposed hand press upwardly against the bottom 12 to lift the bottom away from the flange 20 and slide the food item upwardly away from the container sidewall 30. The opening 18 is sufficiently large that it will accommodate the fingers of one hand to support the bottom 12 and entrée or dessert, while the body portion 10 is removed.

The reheated entrée or dessert can then be placed on a flat serving utensil, with or without the bottom 12.

By virtue of the steeply inclined side walls of the body portion 10, the resulting food product has a unique appearance. Moreover, when the surface has been decorated, that decoration was already finished at the time the food product was purchased by the end user. Thus, the decoration does not have to be applied at the time of final preparation.

At various locations in this specification, numerical values are introduced with the term “about”. For purposes of this specification, any such numerical values should be considered to include values within a tolerance of +/−10%.

It should now be apparent to those skilled in the art that a new, useful, and nonobvious container has been described which represents a substantial improvement over the known containers. Likewise, a new, useful, and nonobvious process of using that container has also been described. It will further be apparent to those skilled in the art that numerous modifications, variations, substitutions, and equivalents may exist for features of the container and the process that do not materially depart from the spirit and scope of the invention. Accordingly, it is expressly intended that all such modifications, variations, substitutions, and equivalents that fall within the spirit and scope of the invention as defined in the appended claims be embraced thereby.

What is claimed is:

1. A process of preparing a food item, comprising the steps of:
providing a container assembly having a body portion fashioned of CPET, and a removable body portion;
placing an uncooked food item in the container assembly;
heating the food item in the container assembly;
cooling the food item in the container assembly;
covering the container assembly with a transparent cover element;
removing the cover element from the container assembly;
thermally treating the food item in the container assembly; and
removing the removable bottom element and the food item from the body portion.

2. The process of claim 25, wherein the thermal treatment step includes thawing the food item.

3. The process of claim 25, wherein the thermal treatment step includes tempering the food item.

4. The process of claim 25, wherein the thermal treatment step includes reheating the food item.

5. The process of claim 25, wherein the thermal treatment step includes microwave heating of the food item.
